(19) United States
(12) Patent Application Publication
(10) Pub. No.: US 2025/0252941 A1
(43) Pub. Date: Aug. 7, 2025

(54) PLECTRUM HOLDER

(71) Applicant: Paul Holcomb, Inlet Beach, FL (US)

(72) Inventor: Paul Holcomb, Inlet Beach, FL (US)

(21) Appl. No.: 18/949,781

(22) Filed: Nov. 15, 2024

Related U.S. Application Data
(60) Provisional application No. 63/600,593, filed on Nov. 17, 2023.

(51) Int. Cl. G10D 3/173

(52) U.S. Cl. CPC G10D 3/173

(57) ABSTRACT

A plectrum holder has a holder body having a top portion and a bottom portion. The top portion is a plectrum clip adapted to receive and store one or more plectrums. The bottom portion is a mounting surface clip adapted to receive and attach to a mounting surface, such as a guitar strap. A user can attach the holder body to a mounting surface and removeably store one or more plectrums in the plectrum clip of the holder body.

### PRIORITY

The present application claims the benefit of domestic priority based on U.S. Provisional Patent Application 63/600,593 filed on Nov. 17, 2023, the entirety of which is incorporated herein by reference.

### BACKGROUND

Guitar playing is a time-honored tradition that dates back for generations. Much technology has gone into the design of the guitar, but relatively little has been developed in terms of the tools used to play a guitar.

A plectrum is a small flat tool used to pluck or strum a stringed instrument. A guitar pick or guitar plectrum is a plectrum specifically designed for guitar playing. Playing a guitar with a plectrum produces a bright sound compared to plucking with the fingertip. Plectrums also offer a greater contrast in tone across different plucking locations. For these reasons and more, most guitar players prefer to use a plectrum when playing. U.S. Pat. Nos. 10,600,392 and 11,823,650, both of which are incorporated herein by reference in their entireties, disclose plectrums with ergonomic contour that are successful in reducing the stress and strain experience by a guitar player and/or assisting a guitar player in feeling an orientation of the plectrum in the fingers.

When playing a guitar or other stringed instrument, the player of the instrument needs quick access to their guitar plectrum. This is especially important in a live setting where guitarists may need to quickly replace a dropped pick or grab a different pick. It is also important for guitarists to have a convenient way to store and access during or between performances. Conventionally, a guitarist will store his or her picks on a holder on a mic stand or in a pocket in a garment. However, this is not ideally convenient. In addition, conventional pick holders are only designed to hold a pick of a particular size and shape and are not universally usable to hold different types of picks.

There is therefore a need for an improved way to store and/or secure a plectrum. There is further a need for a plectrum holder that can store a plectrum on a guitar strap or other material surface. There is further a need for a plectrum holder that can be used to store different size and/or shape plectrums.

### SUMMARY

The present invention satisfies these needs. In one aspect of the invention, an improved manner of storing and/or securing a plectrum is provided.

In another aspect of the invention, a plectrum holder includes a plectrum clip and a mounting surface clip.

In another aspect of the invention, a plectrum holder includes a plectrum clip and a mounting surface clip, the clips being oppositely oriented.

In another aspect of the invention, a plectrum holder includes a plectrum clip and a mounting surface clip adapted to mount to a guitar strap.

In another aspect of the invention, a plectrum holder includes a plectrum clip and a mounting surface clip, the plectrum holder including a gripping member.

In another aspect of the invention, a plectrum holder includes a plectrum clip and a mounting surface clip, the plectrum holder having a triangular or trapezoidal receiving surface.

In another aspect of the invention, a method of clipping a plectrum comprises providing a plectrum clip as described herein and using the plectrum clip as described herein.

In another aspect of the invention, a plectrum holder comprises a holder body having a top portion and a bottom portion, wherein the top portion comprises a plectrum clip adapted to receive and store one or more plectrums, and wherein the bottom portion comprises a mounting surface clip adapted to receive and attach to a mounting surface, wherein a user can attach the holder body to a mounting surface and replaceably store one or more plectrums in the plectrum clip of the holder body.

In another aspect of the invention, a plectrum holder comprises a holder body having a top portion and a bottom portion, wherein the top portion comprises a plectrum clip adapted to receive and store one or more plectrums, and wherein the bottom portion comprises a mounting surface clip adapted to receive and attach to a mounting surface, wherein a user can attach the holder body to a mounting surface and removably store one or more plectrums in the plectrum clip of the holder body, wherein the holder body is S-shaped.

In another aspect of the invention, a plectrum holder comprises a holder body having a top portion and a bottom portion, wherein the top portion comprises a plectrum clip adapted to receive and store one or more plectrums, and wherein the bottom portion comprises a mounting surface clip adapted to receive and attach to a mounting surface, wherein a user can attach the holder body to a mounting surface and removeably store one or more plectrums in the plectrum clip of the holder body, wherein the holder body comprises an upper prong portion, a central body portion, and a lower prong portion, wherein the plectrum clip is formed by the upper prong portion and the central body portion, and wherein the mounting surface clip is formed by the lower prong and the central body portion.

In another aspect of the invention, a plectrum holder comprises a holder body having a top portion and a bottom portion, wherein the top portion comprises a plectrum clip adapted to receive and store one or more plectrums, and wherein the bottom portion comprises a mounting surface clip adapted to receive and attach to a mounting surface, wherein a user can attach the holder body to a mounting surface and removeably store one or more plectrums in the plectrum clip of the holder body, wherein the holder body comprises an upper prong portion, a central body portion, and a lower prong portion, wherein the plectrum clip is formed by the upper prong portion and the central body portion, and wherein the mounting surface clip is formed by the lower prong and the central body portion, wherein the upper prong portion and the central body portion are connected by an upper connection portion that biases the upper prong portion toward the central body portion when the upper prong portion is separated from the central body portion, and wherein upper prong portion includes a plectrum contacting member adapted to contact a plectrum that has been inserted into the plectrum clip and press the plectrum against the central body portion.

In another aspect of the invention, a plectrum holder system comprises a plectrum; and a plectrum holder, the plectrum holder comprising a holder body having a top portion that comprises a plectrum clip adapted to receive the plectrum, wherein a user can removeably store the plectrum in the plectrum clip of the holder body, wherein the plectrum comprises a surface feature, and wherein the plectrum clip comprises a plectrum contacting member that corresponds to the surface feature of the plectrum.

In another aspect of the invention, a plectrum holder system comprises a plectrum; and a plectrum holder, the plectrum holder comprising a holder body having a top portion that comprises a plectrum clip adapted to receive the plectrum, wherein a user can removeably store the plectrum in the plectrum clip of the holder body, wherein the plectrum comprises a surface feature, and wherein the plectrum clip comprises a plectrum contacting member that corresponds to the surface feature of the plectrum, wherein the surface feature of the plectrum is a central hole.

In another aspect of the invention, a method of storing a plectrum comprises providing a plectrum holder comprising a holder body having a top portion and a bottom portion, wherein the top portion comprises a plectrum clip adapted to receive and store one or more plectrums, and wherein the bottom portion comprises a mounting surface clip adapted to receive and attach to a mounting surface, attaching the mounting surface clip to a mounting surface, and inserting a plectrum into the plectrum clip to removeably store the plectrum.

In another aspect of the invention, a method of storing a plectrum comprises providing a plectrum holder comprising a holder body having a top portion and a bottom portion, wherein the top portion comprises a plectrum clip adapted to receive and store one or more plectrums, and wherein the bottom portion comprises a mounting surface clip adapted to receive and attach to a mounting surface, attaching the mounting surface clip to a mounting surface, and inserting a plectrum into the plectrum clip to removeably store the plectrum, wherein the plectrum includes a surface feature and wherein the plectrum clip of the plectrum holder comprises a plectrum contacting member that corresponds to the surface feature of the plectrum.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic side view of a plectrum holder of the invention;

FIG. 1B is a schematic perspective view from the top of the plectrum holder of FIG. 1A;

FIG. 1C is a schematic perspective view from the front of the plectrum holder of FIG. 1A;

FIG. 2A is a schematic side view of another version of a plectrum holder of the invention;

FIG. 2B is a schematic perspective view from the top of the plectrum holder of FIG. 2A;

FIG. 3A is a schematic top view of another version of a plectrum holder of the invention;

FIG. 3B is a schematic perspective view from the top of the plectrum holder of FIG. 3A;

FIG. 3C is a schematic perspective view from the bottom of the plectrum holder of FIG. 3A;

FIG. 3D is a schematic bottom view of the plectrum holder of FIG. 3A;

FIG. 4 is a schematic perspective top view from the top of another version of a plectrum holder of the invention;

FIG. 5 is a schematic perspective view of a plectrum alongside a stack of such plectrums that are insertable into a plectrum holder of the invention;

FIG. 6A is a schematic perspective view of a version of a plectrum holder of the invention in the process of receiving a plectrum for storage;

FIG. 6B is a schematic perspective view of the plectrum holder of FIG. 6A storing the plectrum;

FIG. 7 is a schematic perspective view from above, front, and right side of a version of a plectrum holder of the invention;

FIG. 8 is a schematic perspective view from below, rear, and left side of the plectrum holder of FIG. 7;

FIG. 9 is a schematic top view of the plectrum holder of FIG. 7;

FIG. 10 is a schematic bottom view of the plectrum holder of FIG. 7;

FIG. 11 is a schematic front view of the plectrum holder of FIG. 7;

FIG. 12 is a schematic rear view of the plectrum holder of FIG. 7;

FIG. 13 is a schematic left side view of the plectrum holder of FIG. 7;

FIG. 14 is a schematic perspective view from above, front, and left side of the plectrum holder of FIG. 7 in use;

FIG. 15 is a schematic top view of the plectrum holder of FIG. 7 in use; and

FIG. 16 is a schematic top view of another version of a plectrum holder of the invention in use.

### DESCRIPTION

The present invention relates to a holder for a plectrum for strumming strings of a stringed instrument. Although the plectrum holder is illustrated and described in some instances in the context of being useful as a guitar pick holder, the present invention can be useful in other instances. Accordingly, the present invention is not intended to be limited to the examples and embodiments described herein.

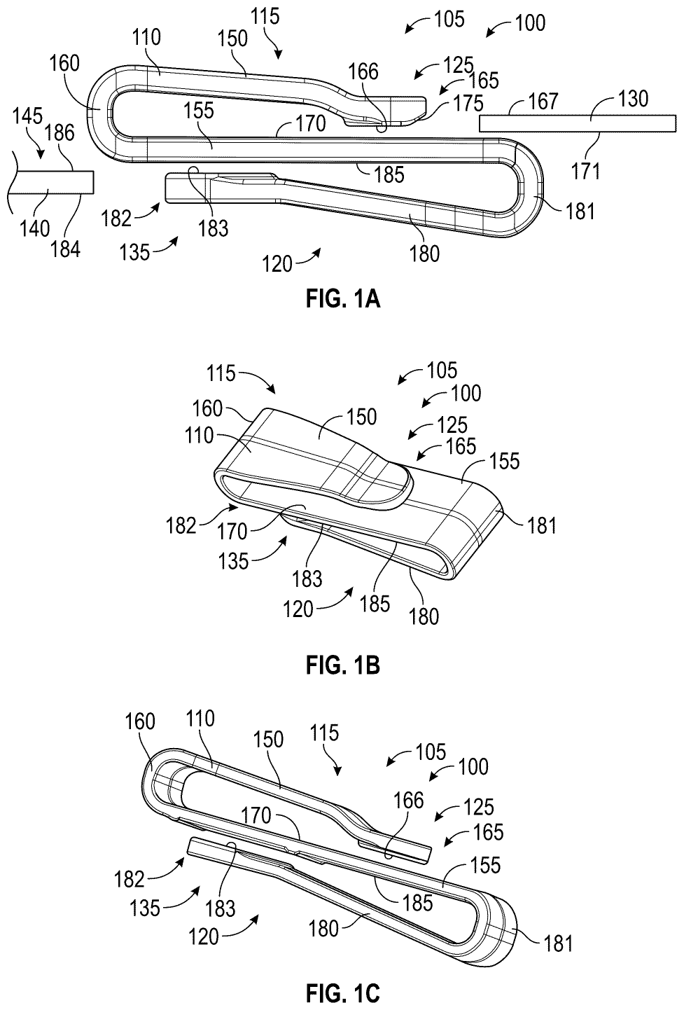

FIG. 1A shows a version of a plectrum holder 100 of the current invention. The plectrum holder 100 includes a plectrum holder body 105. The plectrum holder body 105 has an S-shaped structure 110 that has a top portion 115 and a bottom portion 120. The top portion 115 of the plectrum holder includes a plectrum clip 125 adapted to receive and store a plectrum 130 or a plurality of plectrums. The bottom portion 120 includes a mounting surface clip 135 adapted to receive and attach to a mounting surface 140. In the version shown, the mounting surface 140 is a guitar strap 145. However, the mounting surface 140 can be any other piece of material, such as a part of a garment that can be clipped onto by the mounting surface clip 135. By S-shaped structure it is meant that the plectrum holder body 105 in a version where is has an S-shaped structure when viewed from one or more of its sides has a generally S-shape in that it has a plurality of curves with at least two that curve in substantially opposite directions so as to form opening regions that open substantially opposing sides. Accordingly, the S-shape can be a backwards S, an S with a top curvature larger or smaller than the bottom, an S with additional curved and/or straight sections, and the like.

The plectrum clip 125 of the plectrum holder 100 is made of an upper prong portion 150 that opposes a central body portion 155. The upper prong portion 150 is connected to the central body portion 155 by an upper connection portion 160. The upper connection portion 160 may be curved, as shown in FIG. 1A or may straight and angled or a combination, and is designed to bias the upper prong portion 150 towards the central body portion 155, especially when the upper prong portion 150 is forced away from the central body portion 155. Thus, when the upper prong portion 150 is forced away from the central body portion 150, the upper prong portion 150 is urged back towards the central body portion 155 by the biasing action of the upper connection portion 160. The upper prong portion 150 includes a plectrum contacting member 165 at the forward end of the upper prong portion 150. The plectrum contacting member 165 includes a plectrum contacting surface 166 at a forward end of the upper prong portion 150. The plectrum contacting surface 166 contacts a top surface 167 of a plectrum 130 when the plectrum 130 is being stored in the plectrum holder 100. In its resting configuration, as shown in FIG. 1A, a gap between the plectrum contacting surface 166 and an upper surface 170 of the central body portion 155 is less than or equal to the thickness of the plectrum 130 to be stored, and in another version the contacting surface 166 can contact the upper surface 170 of the central body portion 155. The central body portion 155 of the plectrum holder 100 can have any suitable shape, such as square or rectangular. In one particular version, the central body portion 155 has a partially triangular or trapezoidal receiving surface.

To store the plectrum 150, the plectrum contacting member 165 is moved away from the central body portion 155 so that the gap between the plectrum contacting surface 166 and the upper surface 170 of the central body portion 155 is wide enough to allow a plectrum 130 to be inserted into the gap. Accordingly, the gap opened to a position and/or is forced open by the insertion of a plectrum to a position where the gap is equal to or greater than the thickness of at least a portion of the plectrum 130 and the plectrum is inserted between the upper prong portion 150 and the central body portion 155 so that when the separation force is removed, the plectrum contacting surface 166 presses against the top surface 167 of the plectrum 130 and pushes a bottom surface 171 of the plectrum 130 against the upper surface 170 of the central body portion 150. The friction of the contacting surfaces and/or the force applied by the biased upper prong portion 150 maintain the plectrum 130 within the plectrum clip 125 of the plectrum holder 100. In one version, a tapered forward surface 175 of the plectrum contacting member 165 helps to allow for insertion of the plectrum 130 into the plectrum clip 125. To remove the plectrum 130 from the plectrum clip 130, the plectrum 130 is pulled out of the plectrum clip 125 with sufficient force to overcome the friction and/or bias action of the plectrum clip 125.

The mounting surface clip 135 of the plectrum holder 100 is made of a lower prong portion 180 that opposes the central body portion 155. The lower prong portion 180 is connected to the central body portion 155 by a lower connection portion 181. The lower connection portion 181 may be curved, as shown in FIG. 1A or may straight and angled or a combination, and is designed to bias the lower prong portion 180 towards the central body portion 155 in similar manner to the way the upper prong portion 150 is biased toward the central body portion 155 but in an opposite direction. Thus, when the lower prong portion 180 is forced away from the central body portion 150, the lower prong portion 180 is urged back towards the central body portion 155 by the biasing action of the lower connection portion 181. The lower prong portion 180 includes a mounting surface contacting member 182 at the rearward end of the lower prong portion 180. The mounting surface contacting member 182 includes a mounting surface contacting surface 183 that contacts a first surface 184 of a mounting surface 140 when the mounting surface 130 is being stored to support the plectrum holder 100. In its resting configuration, as shown in FIG. 1A, a gap between the mounting surface contacting surface 183 and the lower surface 185 of the central body portion 155 is less than or equal to the thickness of at least a portion of the mounting surface 140, and in another version, the mounting surface contact surface 183 can contact the lower surface 185 of the central body portion 155 in its resting position.

To mount the plectrum holder 100 to the mounting surface 140, the mounting surface contacting member 182 is moved away from the central body portion 155 manually or by a separation force caused by the insertion of the mounting surface 140 so that the gap is equal to or greater than the thickness of the mounting surface 140, and the mounting surface 140 is inserted between the lower prong portion 180 and the central body portion 155 so that when the separation force is removed, the mounting surface contacting surface 183 presses against the first surface 184 of the mounting surface 140 and pushes a second surface 186 of the mounting surface 140 against the bottom surface 185 of the central body portion 150. The friction of the contacting surfaces and/or the force applied by the biased upper prong portion 150 maintain the mounting surface 140 within the mounting surface clip 135 of the plectrum holder 100. To remove the plectrum holder 100 from the mounting surface 140, the plectrum holder 100 is pulled away from the mounting surface 140 with sufficient force to overcome the friction and/or bias action of the mounting surface clip 135.

In the version shown, the plectrum 130 and the mounting surface 140 are insertable into the plectrum clip 125 and the mounting surface clip 135 of the plectrum holder 100 in different directions of insertion. The plectrum clip 125 is adapted to receive the plectrum 130 in a plectrum insertion direction which is to the left in FIG. 1A. The mounting surface clip 135 is adapted to receive the mounting surface 140 in a mounting surface insertion direction which is to the right in FIG. 1A. In this version, the plectrum insertion direction and the mounting surface insertion direction are different directions, and in the particular version shown are opposite directions, or approximately 180 degrees relative to one another.

The plectrum contacting surface 166 and the mounting surface contacting surface 183 can be sized, shaped, designed, and adapted to desirably contact a plectrum 130 and a mounting surface 140, respectively. In one version, the plectrum contacting surface 166 and the mounting surface contacting surface 183 are substantially the same. This version allows the plectrum clip 115 and the mounting surface clip 125 to be used interchangeably. In another version, the plectrum contacting surface 166 and the mounting surface contacting surface 183 are different with each being designed to advantageously contact a plectrum 130 and a mounting surface 140, respectively. For example, in one version the contact surface area of the mounting surface contacting surface 183 is greater than the contact surface area of the plectrum contacting surface 166. This version allows for a more concentrated contacting force and/or a particularly shaped surface to be used to contact the plectrum 130 so as to allow the plectrum 130 to be easily and conveniently stored or removed. This version also provides a larger contact surface area between the mounting surface contacting surface 183 and the mounting surface 140 so that a greater amount of friction or the like can help secure the plectrum holder 100 on the mounting surface 140. Similarly, the strength of the biases from the upper connection portion 160 and the lower connection portion 181 can be substantially the same, or in another version, the biasing forces can be different to make one of the biases stronger than the other. For example, in one version, it may be desirable to make the grip of the mounting surface clip 135 stronger than the grip of the plectrum clip 125, or vice versa.

The positional and directional references used herein are used solely for describing the plectrum holder 100 in relation to way is it shown in the Figures. For example, the expressions upper and lower are not intended to imply that the plectrum holder 100 must be used in a manner where an upper portion is above a lower portion. The plectrum holder 100 can be flip upside down and/or designed such that the lower portion is positioned above the upper portion. The same holds for the expressions forward and rearward, and the like.

The plectrum holder 100 thus provides an easy and convenient way for a guitarist or player of a stringed instrument to store and access plectrums 130. The plectrum holder 100 can be mounted on a convenient mounting surface 140 so that a plectrum 130 is able to be stored and retrieved from a known and expected location. For example, the plectrum holder 100 can be mounted to a guitar strap 145 to provide a convenient location for the storage of a guitarist's plectrum. This provides particularly convenient storage and retrieval during performance of the stringed instrument. In addition to convenience, the plectrum holder 100 of the present invention offers additional advantages. For example, the upper prong portion 150 can be designed to accommodate various sized and widths of plectrums 130 making the plectrum holder 100 more universally able to handle different size and shape plectrums 130 and/or multiple plectrums 130. Also, a plurality of plectrum holders 100 can be provided on the mounting surface 140 to allow the performer to have a choice of different plectrums to use during a performance and to conveniently be able to access a desired plectrum 130 and to store a plectrum 130 that is not be used at a particular time.

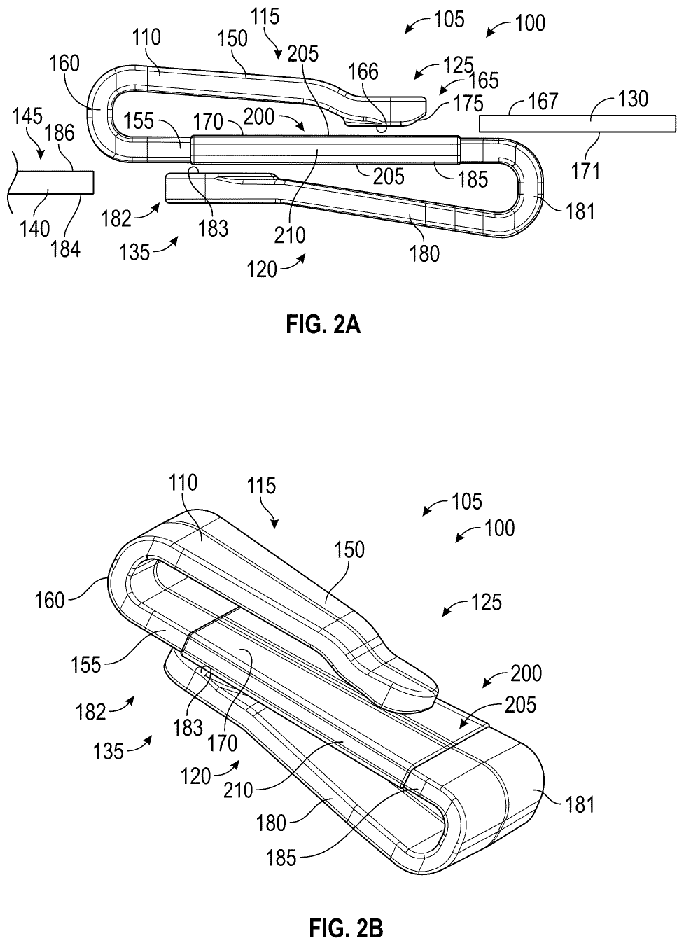

FIGS. 2A and 2B show another version of the plectrum holder 100 of the invention. In this version, the central body portion 155 includes a gripping member 200. The gripping member 200 can be provided to cover the upper surface 170 and/or the lower surface 185 of the central body portion 155. The gripping member 200 has a surface 205 that covers at least a portion of the central body portion 155. The surface 205 of the gripping member 205 thus becomes the upper surface 170 and/or the lower surface 185 of the central body portion 155, and the surface 205 of the gripping member 200 becomes the surface that contacts the bottom surface 171 of the plectrum 130 and/or the second surface 186 of the mounting surface 140 in use. The surface 205 of the gripping member has a higher coefficient of friction than the central body portion 155 and thereby helps to provide a better grip on the plectrum 130 and/or the mounting surface 140. In the version shown in FIGS. 2A and 2B, the gripping member 200 is a sleeve 210 that encircles the central body portion 155. The gripping member sleeve 210 can be a continuous member or can include holes or notches therein. Alternatively, the gripping member 200 can be separate members on one or both sides of the central body portion 155, or the gripping member 200 can be a coating on one or the other sides of the central body portion 155.

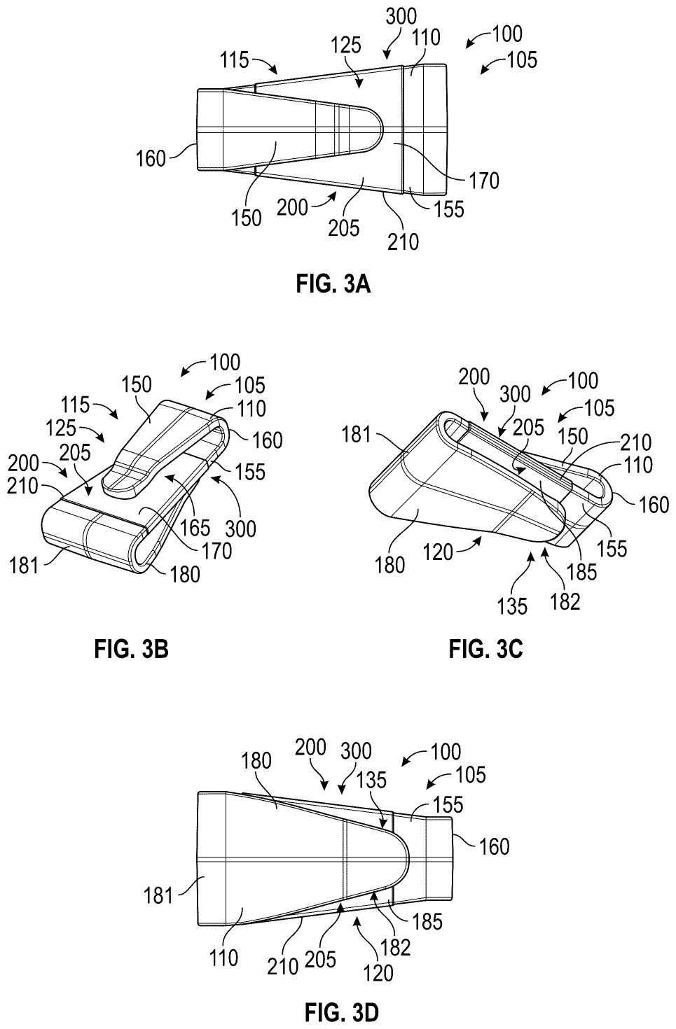

FIGS. 3A through 3D show another version of the plectrum holder 100 of the invention. In this version, the central body portion 155 has a tapered shaped 300 to create a triangular or trapezoidal shaped surface for receiving the plectrum 130 and/or the mounting surface 140. The tapered shaped can help to prevent twisting of a stored plectrum 130 within the plectrum clip 125 and/or can help prevent twisting of the plectrum holder 100 on the mounting surface 140.

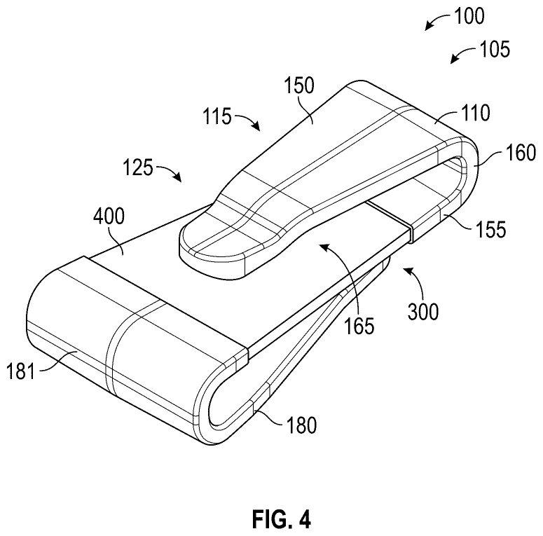

FIG. 4 shows another version of the plectrum holder 100 of the invention. In this version, the central body portion 155 is provided with a recess 400 that is sized and shaped to receive the gripping member 200. The recess 400 helps prevent the gripping member 200 from sliding on the central body portion 155.

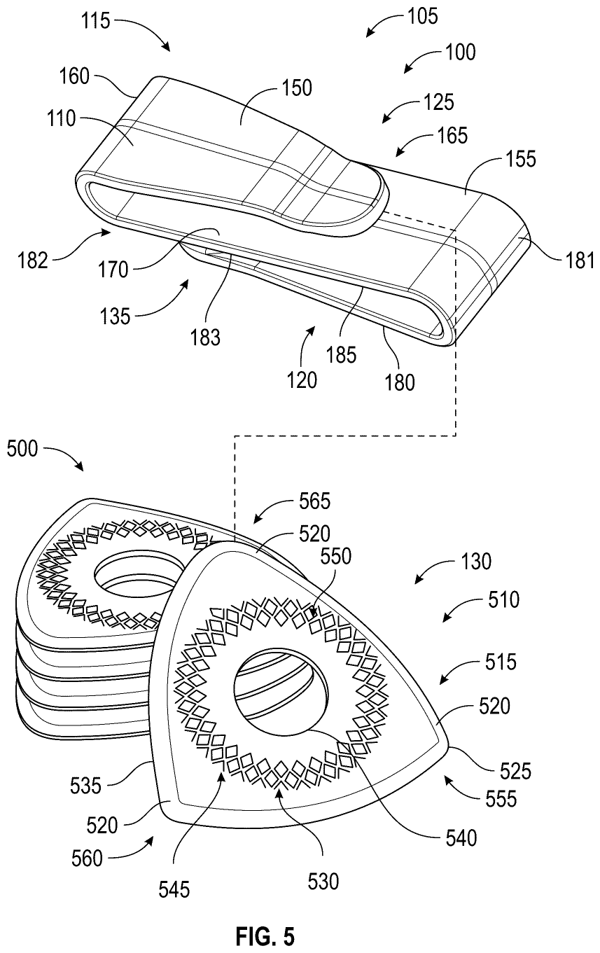

FIG. 5 shows a version of a plectrum 130 that may be used with the plectrum holder 100, such as the plectrum holder 100 of FIG. 1A, alongside a stack 500 of a plurality of the plectrums 130. The plectrum 130, also known as a pick, is grasped by a user and is used to strum a stringed instrument, such as a guitar, mandolin, banjo, bass guitar, and the like. A plectrum 130, such as the one shown, that is specifically designed for a guitar is often referred to as a guitar pick or guitar plectrum. In the version of FIG. 5, the plectrum 130 has a plectrum body 510 having one or more angled corner portions 515. At least one of the angled corner portions 515 forms a pick tip 520 having an edge 525 that can be used to contact the strings of a stringed instrument and to strum or pluck one or more of the stings to make music. The plectrum 130 has a front face 530 and a rear face 535. A user grasps the plectrum 130 by contacting the front face 530 with the user's thumb and the rear face 535 with a user's finger, such as an index finger and/or middle finger, or vise-versa. The plectrum 130 is thus squeezed between the user's thumb and finger in such a way that a pick tip 520 and its associated edge 525 is positioned so that it may contact the strings of the stringed instrument. The plectrum 130 may be provided with a central hole 540 or depressed region or may be without such hole and/or depressed region. The plectrum 130 may have a surface texture 545 or may be untextured. The front face 530 and/or the rear face 535 may be provided with a contour 550, such as a change in thickness, projections, and/or recesses, that help a user grip the plectrum 130 and/or relieve stress from the gripping of the plectrum 130. Alternatively, the plectrum 130 can be flat and have no contours. In the version of the plectrum 130 shown in FIG. 5, the plectrum 100 has a plurality of pick tips 520, such as the first tip 555, second tip 560, and third tip 565, that are all substantially the same. Alternatively, the plectrum 130 can pick tips 520 that are different, such as for example the plectrum 130 can have a first tip 550 having a first thickness, a second tip 555 having a second thickness different than the first thickness, and optionally a third tip 560 having a third thickness. Alternatively or additionally, the different pick tips 520 can have a different shape than one another and/or can be made from a different material than one another.

The plectrum 130 may be gripped and manipulated in any of numerous manners. For example, the plectrum 130 may be gripped with two fingers, such as the thumb and the index finger or the thumb and the middle finger. Alternatively, the plectrum may be gripped with three fingers, such as the thumb, the index finger, and the middle finger. The motion of the plectrum 130 against the strings of the stringed instrument also can vary from user to user. For example, a user may hold the plectrum very stiffly between the thumb and index finger, locking the thumb joint and striking with the surface of the pick nearly parallel to the string. Alternatively, a user may use a technique where the thumb joint is bent on the downstroke and straightened on the upstroke, causing the tip of the pick to move in a circular pattern, which can allow speed and fluidity. When the plectrum 130 is to be stored, it can be inserted into a plectrum holder 100, as shown and as discussed above.

The plectrum 130 according to the invention can have any size and shape suitable for being used as a plectrum. For example, the plectrum 130 can be generally round, circular, oval, ovate, triangular, square, rectangular, or other polygonal shape. In the version shown, the plectrum 130 has a general triangular shape. The plectrum 130 can have any suitable thickness. For example, in one version, the plectrum 130 has a thickness of from about 0.3 mm to about 6 mm and in another version from about 0.6 mm to about 4 mm. In one version, the plectrum 130 has a length dimension of from about 20 mm to about 50 mm and in another version from about 25 mm to about 38 mm. For a circular plectrum, the length dimension can be the diameter of the circular shape. For other shapes, the length dimension can be either the longest dimension in the general plane of the plectrum that passes through the center of the plectrum and/or the shortest dimension on the general plane of the plectrum that passes through the center of the plectrum.

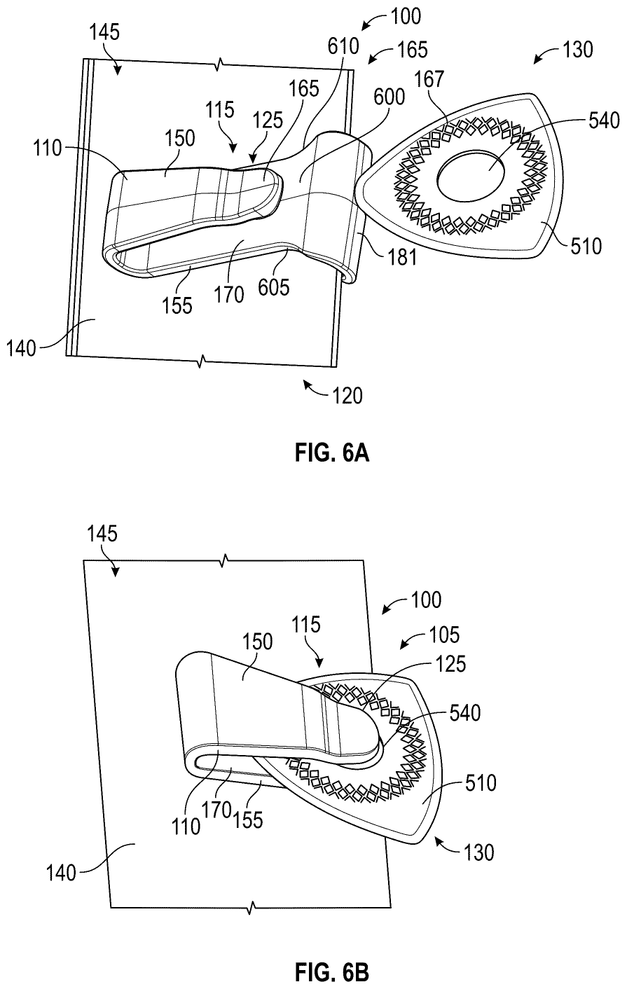

FIG. 6A shows another version of a plectrum holder 100 mounted on a mounting surface 140, such as a guitar strap 145, and in a position ready to receive a plectrum 130 for storage. The plectrum holder 100 of FIG. 6A is similar to the plectrum holder 100 of FIG. 1A but the central body portion 155 including a hip portion 600 design to help facilitate removal of a plectrum 130 from the plectrum clip 125 of the plectrum holder 100. The hip portion 600 includes a left recessed portion 605 and a right recessed portion 610 provided at the forward end of the plectrum body 110. The hip portion 600 and the recessed portions 605, 610 facilitate the removal of the plectrum from the plectrum holder 100 by providing space for the fingers of a user to access the plectrum 100. In addition, the extended area created by the hip portion 600 at the lower connection portion 181 also helps prevent rotation of the plectrum holder 100 on the mounting surface 140, such as a guitar strap 145, thus providing a more stable connection. FIG. 6B shows the plectrum 130 clipped into the plectrum clip 125 of the plectrum holder 100 with the hip portion 600 hidden below the plectrum 130.

As also can be seen in FIGS. 6A and 6B, the plectrum contact member 165 and/or the plectrum contacting surface 166 can be shaped to correspond to a contour or feature of the plectrum 130. In the particular version shown, the plectrum contacting member 165 is shaped to engage a central hole 540 or depressed portion in the plectrum 130 to better secure the plectrum 130 in the plectrum clip 125. This allows the plectrum 130 to snap into engagement within the plectrum clip 125 of the plectrum holder 100. Upon removal, the plectrum body 510 will urge the upper prong portion 150 away from the central body portion 155 against the bias of the upper connection portion 160 as the plectrum 130 slides out of engagement with the plectrum clip 125.

In this regard, the invention can be embodied as a plectrum holder system that comprises a plectrum holder 100 and one or more plectrums 130. In one version, the plectrum holder system can comprise one or more plectrums 130 that have a surface feature, such as a central hole 540 or depression or a different contour 550, and the plectrum holder 100 of the plectrum holder system can include a plectrum contacting member 165 that is sized and shaped to mate with and/or match the contour of the surface feature of the plectrum 130. In one particular version, the plectrum 130 can have a central hole 540 and the plectrum contacting member 165 can have a size and shape that corresponds to the central hole 540. In another version, the central hole 540 is replaced by a central depression that is similar to the hole but does not extend all the way through the thickness of the plectrum 130.

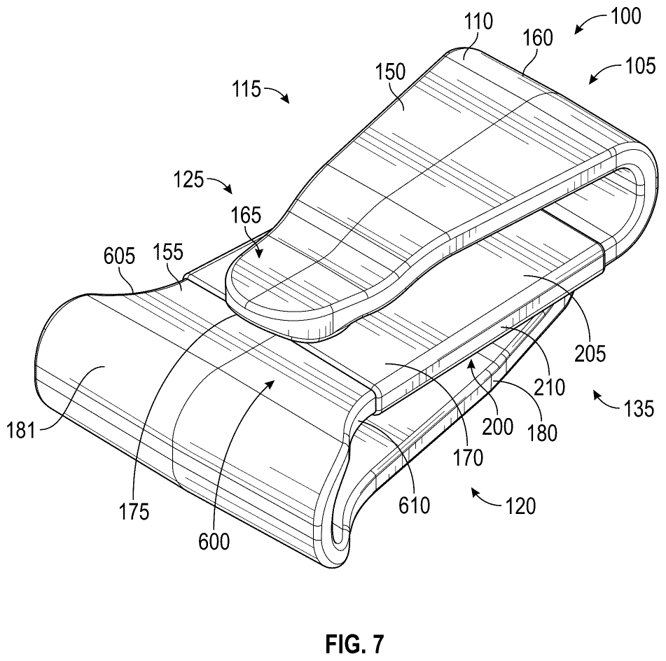

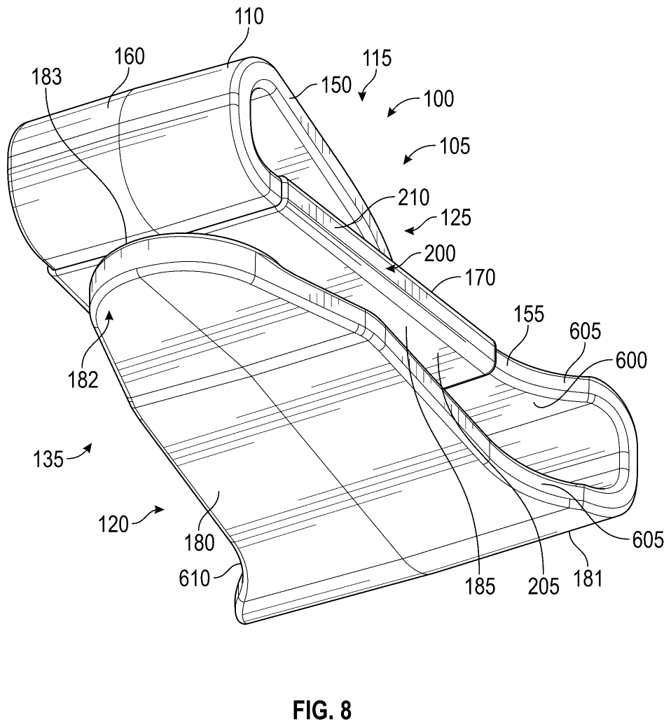

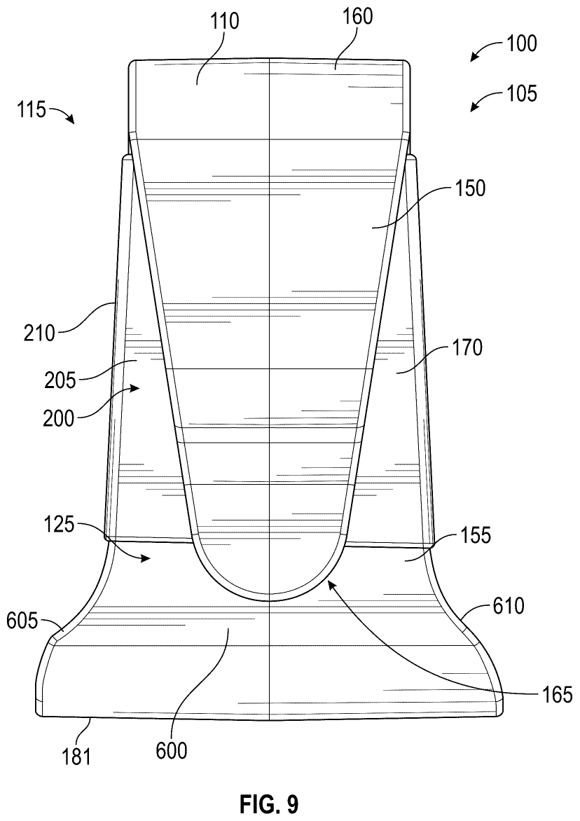

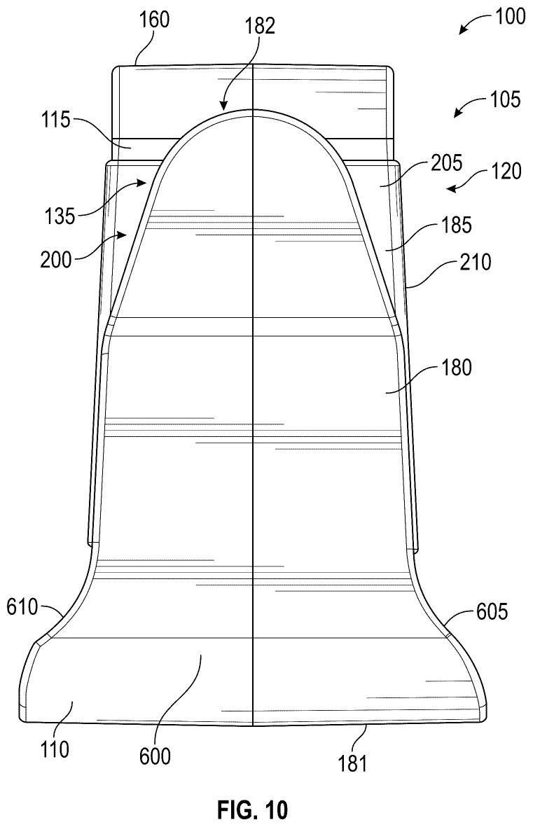

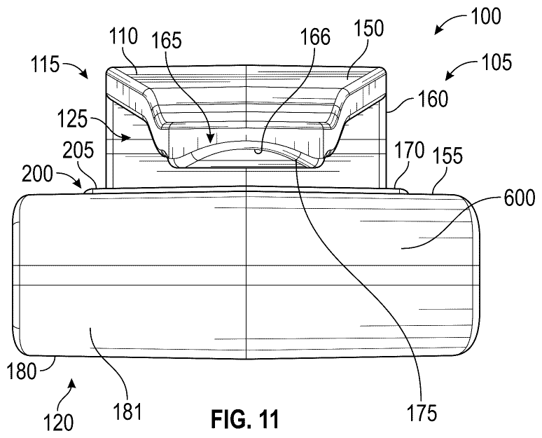

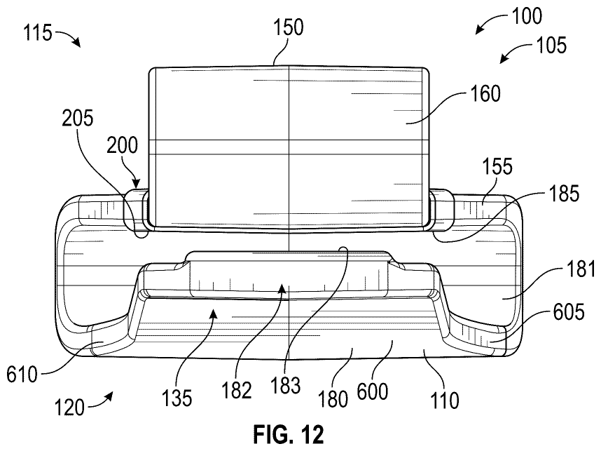

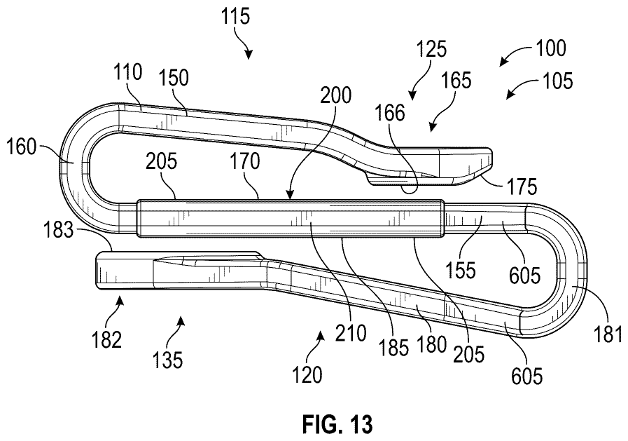

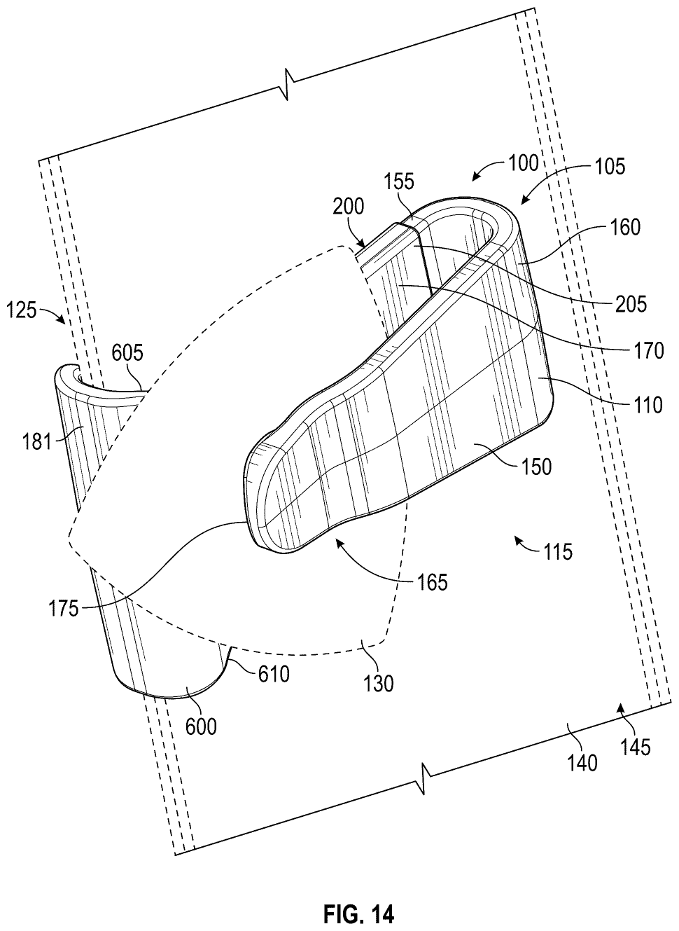

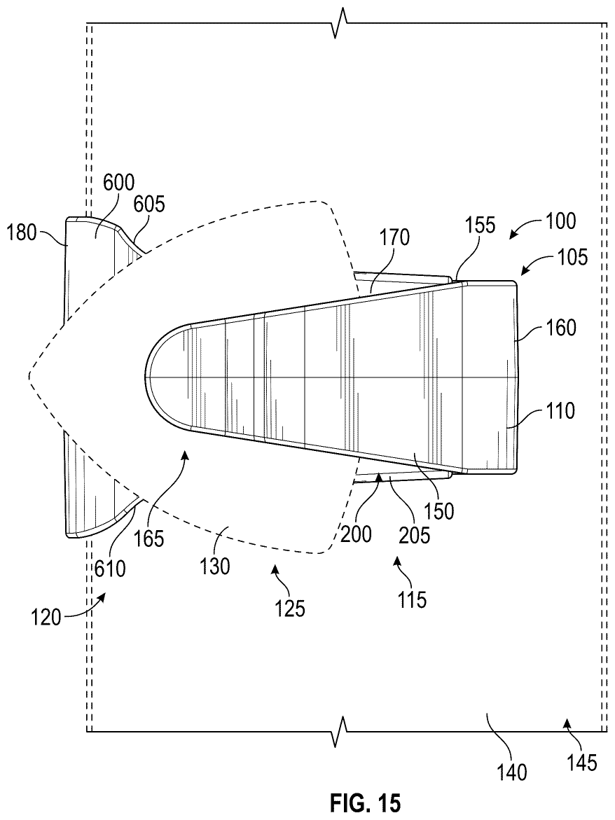

FIGS. 8 through 15 show another version of the plectrum holder 100 of the invention. The version of FIGS. 8 through 15 is similar the version of FIGS. 6A and 6B but with a gripping member 200. FIG. 7 is a perspective view from above, front, and right side of the plectrum holder 100. FIG. 8 is a perspective view from below, rear, and left side of the plectrum holder 100. FIG. 9 is a top view of the plectrum holder 100. FIG. 10 is a bottom view of the plectrum holder 100. FIG. 11 is a front view of the plectrum holder 100. FIG. 12 is a rear view of the plectrum holder 100. FIG. 13 is a left side view of the plectrum holder 100. FIG. 14 is a perspective view from above, front, and left side of the plectrum holder 100 attached to a mounting surface 140, such as a guitar strap 145. FIG. 15 is a top view of the plectrum holder 100 attached to a mounting surface 140, such as a guitar strap 145.

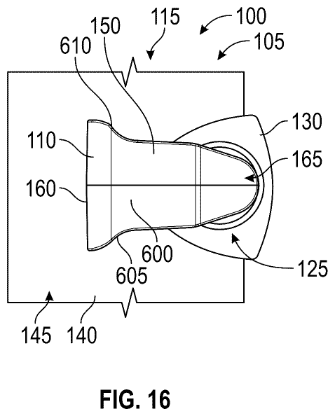

FIG. 16 shows another version of a plectrum holder of the invention. The plectrum holder 100 of FIG. 16 is similar to the version of FIGS. 6A and 6Bm, but in the FIG. 16 version, the hip portion 600 is provided on the rearward side of the upper prong portion 150 of the plectrum holder 100 to create space for the fingers of the user to access the plectrum 130 to remove it from the plectrum holder 100.

The plectrum holder 100 has been exemplified herein in the form of an S-shaped body 110 that receives the plectrum 130 from the front and that receives the mounting surface 140 from the rear. However, the body can have any different shape. For example, the body can be an E-shaped body that receives the plectrum 130 and the mounting surface 140 from the same direction or side.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A plectrum holder comprising:
a holder body having a top portion and a bottom portion, wherein the top portion comprises a plectrum clip adapted to receive and store one or more plectrums, and wherein the bottom portion comprises a mounting surface clip adapted to receive and attach to a mounting surface,
wherein a user can attach the holder body to a mounting surface and removeably store one or more plectrums in the plectrum clip of the holder body.

2. A plectrum holder according to claim 1 wherein the holder body is S-shaped.

3. A plectrum holder according to claim 1 wherein the holder body comprises an upper prong portion, a central body portion, and a lower prong portion, wherein the plectrum clip is formed by the upper prong portion and the central body portion, and wherein the mounting surface clip is formed by the lower prong and the central body portion.

4. A plectrum holder according to claim 3 wherein the upper prong portion and the central body portion are connected by an upper connection portion that biases the upper prong portion toward the central body portion when the upper prong portion is separated from the central body portion.

5. A plectrum holder according to claim 3 wherein upper prong portion includes a plectrum contacting member adapted to contact a plectrum that has been inserted into the plectrum clip and press the plectrum against the central body portion.

6. A plectrum holder according to claim 5 wherein the plectrum contacting member has a tapered forward end.

7. A plectrum holder according to claim 3 wherein the upper prong portion and the central body portion are connected by an upper connection portion that biases the upper prong portion toward the central body portion when the upper prong portion is separated from the central body portion, and wherein upper prong portion includes a plectrum contacting member adapted to contact a plectrum that has been inserted into the plectrum clip and press the plectrum against the central body portion.

8. A plectrum holder according to claim 7 wherein the lower prong portion and the central body portion are connected by a lower connection portion that biases the lower prong portion toward the central body portion when the lower prong portion is separated from the central body portion, and wherein the lower prong portion includes a plectrum contacting member adapted to contact a plectrum that has been inserted into the plectrum clip and press the plectrum against the central body portion.

9. A plectrum holder according to claim 8 wherein the plectrum clip is adapted to receive the plectrum in a plectrum insertion direction, wherein the mounting surface clip is adapted to receive the mounting surface in a mounting surface insertion direction, and wherein the plectrum insertion direction and the mounting surface insertion direction are different directions.

10. A plectrum holder according to claim 8 wherein the wherein the plectrum clip is adapted to receive the plectrum in a plectrum insertion direction, wherein the mounting surface clip is adapted to receive the mounting surface in a mounting surface insertion direction, and wherein the plectrum insertion direction and the mounting surface insertion direction are opposite directions.

11. A plectrum holder according to claim 3 wherein the central body portion includes a gripping member having a coefficient of friction higher than the rest of the central body portion.

12. A plectrum holder according to claim 1 wherein the plectrum clip is adapted to receive the plectrum in a plectrum insertion direction, wherein the mounting surface clip is adapted to receive the mounting surface in a mounting surface insertion direction, and wherein the plectrum insertion direction and the mounting surface insertion direction are different directions.

13. A plectrum holder according to claim 1 wherein the wherein the plectrum clip is adapted to receive the plectrum in a plectrum insertion direction, wherein the mounting surface clip is adapted to receive the mounting surface in a mounting surface insertion direction, and wherein the plectrum insertion direction and the mounting surface insertion direction are opposite directions.

14. A plectrum holder system comprising:
a plectrum; and
a plectrum holder, the plectrum holder comprising a holder body having a top portion that comprises a plectrum clip adapted to receive the plectrum,
wherein a user can removeably store the plectrum in the plectrum clip of the holder body, wherein the plectrum comprises a surface feature, and wherein the plectrum clip comprises a plectrum contacting member that corresponds to the surface feature of the plectrum.

15. A plectrum holder system according to claim 14 wherein the surface feature of the plectrum is a central hole.

16. A plectrum holder system according to claim 14 wherein the surface feature of the plectrum is a depression having a reduced thickness.

17. A plectrum holder system according to claim 14 wherein the holder body also has a bottom portion, wherein the bottom portion comprises a mounting surface clip adapted to receive and attach to a mounting surface, wherein a user can attach the holder body to a mounting surface and removeably store one the plectrum on the holder body while the holder body is attached to the mounting surface.

18. A plectrum holder system according to claim 13 wherein the holder body comprises an upper prong portion and a central body portion, wherein the plectrum clip is formed by the upper prong portion and the central body portion, and wherein the upper prong portion and the central body portion are connected by an upper connection portion that biases the upper prong portion toward the central body portion when the upper prong portion is separated from the central body portion.

19. A method of storing a plectrum, the method comprising:
providing a plectrum holder comprising a holder body having a top portion and a bottom portion, wherein the top portion comprises a plectrum clip adapted to receive and store one or more plectrums, and wherein the bottom portion comprises a mounting surface clip adapted to receive and attach to a mounting surface,
attaching the mounting surface clip to a mounting surface, and
inserting a plectrum into the plectrum clip to removeably store the plectrum.

20. A method according to claim 19 wherein the plectrum includes a surface feature and wherein the plectrum clip of the plectrum holder comprises a plectrum contacting member that corresponds to the surface feature of the plectrum.
